(19) United States
(12) Patent Application Publication
(10) Pub. No.: US 2024/0253261 A1
(43) Pub. Date: Aug. 1, 2024

(54) CRYSTAL BAR SLICER, CRYSTAL BAR SLICING SYSTEM AND LOADING METHOD THEREOF

(71) Applicant: ZHEJIANG JINGSHENG M & E CO., LTD, Shaoxing (CN)

(72) Inventors: Jianwei CAO, Shaoxing (CN); Liang ZHU, Shaoxing (CN); Jiabin LU, Shaoxing (CN); Jinrong WANG, Shaoxing (CN); Feng ZHOU, Shaoxing (CN); Linjian FU, Shaoxing (CN); Lijiang MA, Shaoxing (CN); Yuanyao CHENG, Shaoxing (CN)

(21) Appl. No.: 18/227,933

(22) Filed: Jul. 30, 2023

Related U.S. Application Data
(63) Continuation of application No. PCT/CN2023/097439, filed on May 31, 2023.

(30) Foreign Application Priority Data
Feb. 1, 2023 (CN) 202310100041.7

(51) Int. Cl. B26D 7/06; B25J 11/00; B26D 7/01

(52) U.S. Cl. CPC B26D 7/0683; B25J 11/0055; B26D 7/01

(57) ABSTRACT

The present disclosure provides a crystal bar slicer, a crystal bar slicing system and a loading method thereof. The crystal bar slicer includes a frame body, a cutting shaft and a holding mechanism. The frame body is provided with a slicing chamber and a feeding channel. The slicing chamber is in front of the feeding channel. A sidewall of the slicing chamber is provided with a feeding port, and a rear end of the feeding channel is in communication with outside of the frame body. A front end of the feeding channel is in communication with the slicing chamber via the feeding port. The cutting shaft is disposed in the slicing chamber, and the holding mechanism is configured to drive the crystal holder to move relative to the cutting shaft. The crystal bar slicing system includes the crystal bar slicer, a mechanical hand and a stockpiling region. The loading method includes loading a material with the mechanical hand.

### CROSS-REFERENCE TO RELATED APPLICATIONS

This application is a continuation of international patent application No. PCT/CN2023/097439, filed on May 31, 2023, which itself claims priority to Chinese patent application No. 2023101000417, filed on Feb. 1, 2023, and titled “CRYSTAL BAR SLICER, CRYSTAL BAR SLICING SYSTEM AND LOADING METHOD AND UNLOADING METHOD THEREOF”. The contents of the above identified applications are hereby incorporated herein in their entireties by reference.

### TECHNICAL FIELD

The present disclosure relates to the field of crystal bar slicing, in particular, to a crystal bar slicer, a crystal bar slicing system and a loading method thereof.

### BACKGROUND

In a slicer in the related art, both a feeding channel and a human-operated region are located in front of the slicing chamber. Since the feeding process of conveying a crystal holder through the feeding channel to the slicing chamber is totally carried out by a mechanical hand. Thus, the mechanical hand can easily interfere with an operator in the human-operated region, causing a potential safety hazard.

### SUMMARY

In view of above, it is necessary to provide a crystal bar slicer, a crystal bar slicing system and a loading method thereof to solve the problem of low slicing efficiency of a slicer.

A technical solution provided in the present disclosure is shown hereinafter.

A crystal bar slicer, which includes a frame body, a cutting shaft and a holding mechanism. The frame body is provided with a slicing chamber and a feeding channel. The slicing chamber is in front of the feeding channel. A rear sidewall of the slicing chamber is provided with a feeding port, and a rear end of the feeding channel is in communication with outside of the frame body. A front end of the feeding channel is in communication with the slicing chamber via the feeding port. A crystal holder is capable of entering the slicing chamber through the feeding channel. The cutting shaft is disposed in the slicing chamber, and the holding mechanism is configured to drive the crystal holder to move towards or away from the cutting shaft.

In some embodiments, the rear end of the feeding channel is open, and configured to provide a space for allowing a mechanical hand to move.

In some embodiments, a sidewall of the slicing chamber is further provided with at least one discharging port. The at least one discharging port is in communication with the outside of the frame body, and the crystal holder is capable of leaving the slicing chamber through the at least one discharging port.

In some embodiments, the feeding port is configured to allow the crystal holder and a cut crystal bar to leave the slicing chamber.

In some embodiments, a human-operated region is located in front of the frame body.

The present disclosure further provides a crystal bar slicing system, including a crystal bar slicer, a mechanical hand and a stockpiling region. The mechanical hand is configured to pick up a crystal holder and a crystal bar to be cut from the stockpiling region and convey the crystal holder and the crystal bar to be cut to a slicing chamber.

In some embodiments, the mechanical hand is further configured to pick up the crystal holder and a cut crystal bar from the discharging port and/or the feeding port, and convey the crystal holder and the cut crystal bar to the stockpiling region.

In some embodiments, the mechanical hand is capable of moving in a preset moving region, the discharging port is located in the preset moving region, and the feeding port and/or a rear end of the feeding channel are located in the preset moving region. The stockpiling region is located on a material-conveying mechanism. When the material-conveying mechanism moves to the preset moving region, the mechanical hand is capable of picking up the crystal holder from the stockpiling region or placing the crystal holder on the stockpiling region.

In some embodiments, the crystal bar slicing system of the present disclosure further includes a sliding rail. The sliding rail is disposed on a ceiling or a floor. The mechanical hand is slidably disposed on the sliding rail, so that the mechanical hand is capable of moving between the stockpiling region and the crystal bar slicer.

In some embodiments, the crystal bar slicing system of the present disclosure includes a plurality of the crystal bar slicers. All of the plurality of crystal bar slicers are disposed at one side of the sliding rail or beside both sides of the sliding rail. The plurality of crystal bar slicers disposed at the same side of the sliding rail are disposed side-by-side, and a feeding channel of each of the plurality of crystal bar slicers is perpendicular to the siding rail.

In some embodiments, the mechanical hand is provided with a first pushing mechanism. When the mechanical hand is carrying the crystal holder, the first pushing mechanism is configured to transfer the crystal holder to the slicing chamber.

In some embodiments, the mechanical hand includes two holding arms opposite to each other. The two holding arms cooperate with each other to clip or release the crystal holder.

In some embodiments, the stockpiling region is movable or fixed relative to the crystal bar slicer.

The present disclosure further provides a loading method of a crystal bar slicer, including the following steps: picking up a crystal holder with a mechanical hand, and conveying the crystal holder to a feeding channel or a feeding port; controlling the crystal holder and placing the crystal holder in a slicing chamber; completely pushing the crystal holder into the slicing chamber; and controlling the crystal holder and the mechanical hand to separate the mechanical hand from the crystal holder, or, picking up a crystal holder with a mechanical hand and conveying the crystal holder to a feeding channel or a feeding port; and conveying the crystal holder into a slicing chamber with a pulling mechanism disposing in the slicing chamber.

In some embodiments of the present disclosure, the mechanical hand is provided with a first pushing mechanism, and the first pushing mechanism is configured to completely push the crystal holder into the slicing chamber.

In some embodiments of the present disclosure, a process of completely pushing the crystal holder into the slicing chamber includes the following steps: the mechanical hand is provided with a protrusion, after the crystal holder is separated from the mechanical hand, the protrusion is opposite to the crystal holder, so that the protrusion is capable of pushing the crystal holder completely into the slicing chamber, or, after the crystal holder separates from the mechanical hand, a part of the mechanical hand is opposite to the crystal holder, so that the mechanical hand is capable of pushing the crystal holder completely into the slicing chamber.

In some embodiments of the present embodiment, the mechanical hand is disposed on a moving mechanism, and the moving mechanism is configured to control the mechanical hand to push the crystal holder to the slicing chamber.

In some embodiments of the present embodiment, the mechanical hand includes two holding arms disposed opposite to each other, and the two holding arms cooperate with each other to clip or release the crystal holder. The two holding arms is capable of clipping the crystal holder, so that a center of gravity of the crystal holder transfers to the slicing chamber, and then releasing the crystal holder.

The present disclosure further provides an method of unloading material of a crystal bar slicer, including the following steps: moving a mechanical hand to a discharging port; moving a crystal holder in the slicing chamber to the mechanical hand with a second pushing mechanism disposing in the slicing chamber, so that a gravity center of the crystal holder falls within the mechanical hand; and the mechanical hand is configured to lock the crystal holder, or, moving a mechanical hand to a discharging port; moving a part of a crystal holder out of a slicing chamber to make a center of gravity of the crystal holder move towards the discharging port, moving the mechanical hand into the slicing chamber to support the center of gravity of the crystal holder; and conveying the crystal holder out of the slicing chamber with the mechanical hand.

In some embodiments of the present disclosure, the mechanical hand is disposed on a moving mechanism. After the mechanical hand locks the crystal holder, the moving mechanism is capable of controlling the mechanical hand to move towards a direction away from the slicing chamber, so that the crystal holder can be moved out of the slicing chamber.

In some embodiments of the present disclosure, the mechanical hand includes two holding arms opposite to each other. The two holding arms cooperate with each other to hold or release the crystal holder. When the second pushing mechanism pushes the crystal holder towards the holding arm, the holding arm is configured to support a part of the crystal holder.

When the mechanical hand of the present disclosure moves to the discharging port, the mechanical hand contacts an edge of the discharging port or at least a part of the mechanical hand locates in the slicing chamber.

Details of one or more embodiments of the present disclosure will be set forth in the accompanying drawings and description hereinafter. Other features, objects, and advantages of the present disclosure will become apparent from the specification, the accompanying drawings, and the claims.

### BRIEF DESCRIPTION OF THE DRAWINGS

In order to illustrate the embodiments of the present disclosure more clearly, the drawings used in the embodiments will be described briefly. Apparently, the following described drawings are merely for the embodiments of the present disclosure, and other drawings can be derived by those of ordinary skill in the art without any creative effort.

FIG. 1 is a structural schematic diagram of a crystal bar slicer in some embodiments of the present disclosure.

FIG. 2 is a structural schematic diagram of a crystal bar slicer in some embodiments of the present disclosure from another angle of view.

FIG. 3 is a stereo schematic diagram of a frame body in some embodiments of the present disclosure.

FIG. 4 is a stereo schematic diagram of a frame body in some embodiments of the present disclosure from another angle of view.

FIG. 5 is a top view of a frame body in some embodiments of the present disclosure.

FIG. 6 is a structural schematic diagram of a holding mechanism in some embodiments of the present disclosure.

FIG. 7 is a planar layout diagram of a crystal bar slicing system in some embodiments of the present disclosure.

FIG. 8 is a schematic diagram of a crystal bar slicing system in some embodiments of the present disclosure.

FIG. 9 is a structural schematic diagram of a mechanical hand in some embodiments of the present disclosure.

1 represents a frame body; 11 represents a slicing chamber; 111 represents a cutting shaft; 1111 represents a cutting line; 112 represents a holding mechanism; 113 represents a pulling mechanism; 114 represents a second pushing mechanism; 120 represents a feeding channel; 12 represents a feeding port; 121 represents a third sidewall; 10 represents a discharging port; 13 represents a fourth discharging port; 131 represents a fourth sidewall; 14 represents a first discharging port; 141 represents a first sidewall; 15 represents a second discharging port; 151 represents a second sidewall; 16 represents a fifth discharging port; 17 represents a line accommodating cavity; 18 represents an axle hole; 2 represents a motor mounting base; A represents a crystal bar slicer; 3 represents a stockpiling region; 31 represents a crystal holder; 32 represents a material-conveying mechanism; 33 represents a crystal bar; 4 represents a sliding rail; 5 represents a lifting mechanism; 6 represents a moving mechanism; 7 represents a mechanical hand; 71 represents a first pushing mechanism; 711 represents a protrusion; 72 represents a holding arm; 73 represents a sky-rail robot; 74 represents a ground-rail robot; 8 represents a ceiling; and 9 represents a floor.

### DETAILED DESCRIPTION

The technical solutions in the embodiments of the present disclosure will be clearly and completely described below in conjunction with the accompanying drawings in the embodiments of the present disclosure. Obviously, the described embodiments are only a part of the embodiments of the present disclosure, and not all of the embodiments. Based on the embodiments in the present disclosure, all other embodiments obtained by a person of ordinary skill in the art without making creative labor fall within the scope of protection of the present disclosure.

In the description of the present application, it is to be understood that the terms “center”, “longitudinal”, “transverse”, “length”, “width”, “thickness”, “up,” “down,” “front,” “back,” “left”, “right”, “vertical”, “horizontal”, “top”, “bottom”, “inner”, “outer”, “clockwise”, “anticlockwise”, “axial”, “radial”, “circumferential”, and the like indicate an orientation or positional relationship based on the orientation or positional relationship shown in the figures. These terms are used only for the convenience and simplicity of describing the present disclosure and are not intended to indicate or imply that the device or element referred to must have a particular orientation, be constructed and operated in a particular orientation, and therefore are not to be construed as a limitation of the present disclosure.

Furthermore, the terms “first” and “second” are used for descriptive purposes only and are not to be understood as indicating or implying relative importance or implicitly specifying the number of technical features indicated. Thus, a feature defined with “first”, “second” may expressly or impliedly include at least one such feature. In the description of the present disclosure, “plurality” means at least two, e.g., two, three, etc., unless otherwise expressly and specifically limited.

In this disclosure, unless otherwise expressly specified and limited, the terms “mounting”, “communicated”, “connected”, “fixed”, etc. shall be understood broadly. For example, it may be a fixed connection, a removable connection, or a one-piece connection; it may be a mechanical connection or an electrical connection; it may be a direct connection or an indirect connection via an intermediate medium, and it may be a communication between two elements or an interactive relationship between the two elements, unless expressly limited otherwise. To one of ordinary skill in the art, the specific meaning of the above terms in this disclosure may be understood on a case-by-case basis.

In the present disclosure, unless otherwise expressly specified and limited, the first feature “on” or “below” the second feature may be a direct contact between the first and second features, or an indirect contact between the first and second features through an intermediate medium. Furthermore, the first feature being “on”, “above” and “disposed on” the second feature may be that the first feature is directly above or diagonally above the second feature, or simply that the first feature is horizontally higher than the second feature. The first feature is “below”, “under” and “underneath” the second feature may be that the first feature is directly below or diagonally below the second feature, or simply that the first feature is less horizontal than the second feature.

It is noted that when an element is said to be “fixed to” or “disposed on” another element, it may be directly on the other element or there may be a centered element. When an element is said to be “connected” to another element, it may be directly connected to the other element or there may be both centered elements. As used herein, the terms “vertical”, “horizontal”, “top”, “bottom”, “left,” “right,” and similar expressions are used herein for illustrative purposes only and are not intended to be the exclusive means of implementation.

### First Embodiment

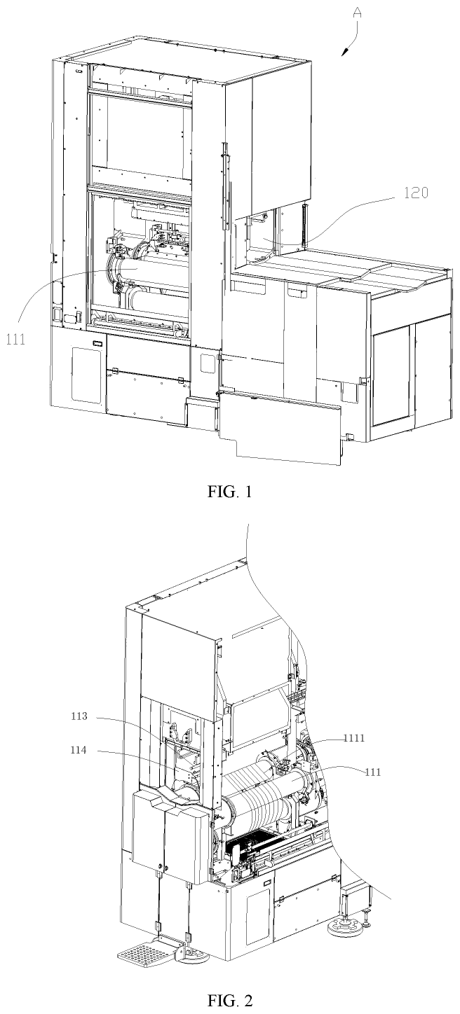

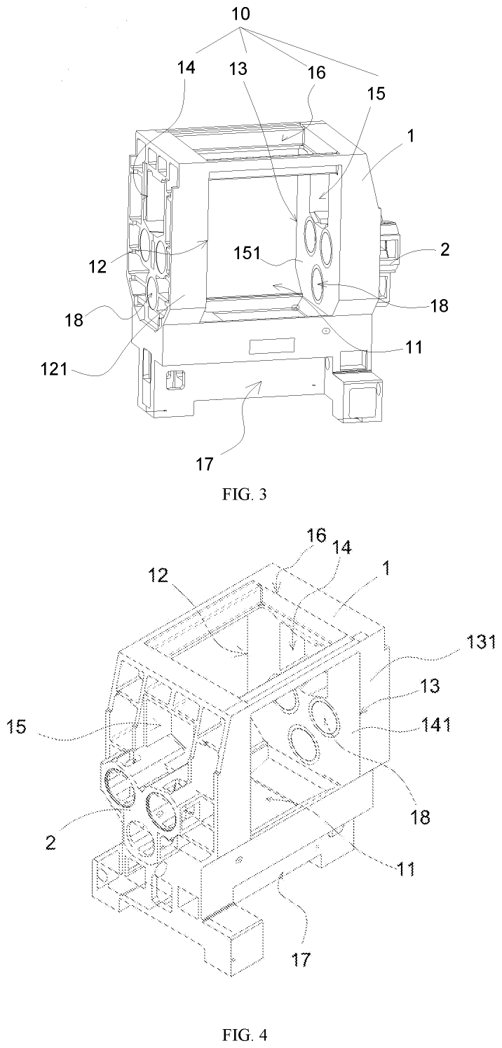

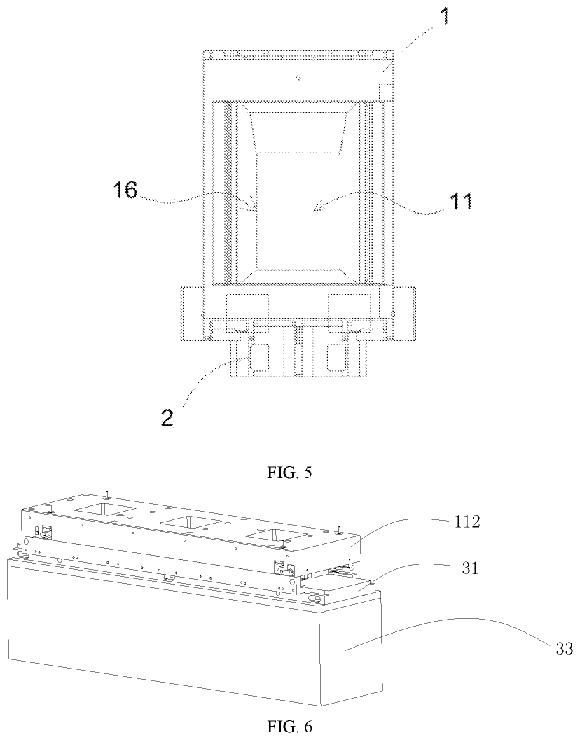

Referring to FIG. 1 to FIG. 6, the present disclosure provides a crystal bar slicer, which includes a frame body 1, a cutting shaft 111 and a holding mechanism 112.

The frame body 1 is provided with a slicing chamber 11 and a feeding channel 120. The slicing chamber 11 is located in front of the feeding channel 120. In the present embodiment, the slicing chamber is approximately a rectangle-shaped chamber. Thus, walls of the slicing chamber 11 include a roof, a bottom wall and sidewalls. The sidewalls of the slicing chamber 11 includes a first sidewall 141 and a second sidewall 151 opposite to each other, and a third sidewall 121 and a fourth sidewall 131 opposite to each other. The third sidewall 121 and the fourth sidewall 131 are located between the first sidewall 141 and the second sidewall 151. The third sidewall 121 is a rear sidewall of the slicing chamber 11.

The walls of the slicing chamber 11 are provided with a feeding port 12 and a discharging port 10, and the feeding port 12 is located on the third sidewall 121. Correspondingly, a rear end of the feeding channel 120 is in communication with outside of the frame body 1, and a front end of the feeding channel 120 is in communication with the slicing chamber 11 via the feeding port 12. The crystal holder 31 can enter the slicing chamber 11 from the rear end of the feeding channel 120 via the feeding port 12. A front side of the frame body 1 is provided with a human-operated region, and an operator can operate the crystal bar slicer in the human-operated region. The mechanical hand 7 can load at the rear end of the feeding channel 120, so as to give way to the operator in the human-operated region, thereby improving safety of a loading process. In the loading process, the mechanical hand 7 can stay at outside of the feeding channel 120, enter the feeding channel 120, or even reach the feeding port 12.

The cutting shaft 111 is disposed in the slicing chamber 11, and provided with a cutting line. After the crystal holder 31 enter the slicing chamber 11, the holding mechanism 112 holds the crystal holder 31 and drive the crystal holder 31 to move towards the cutting shaft 111, so that the cutting line can cut a crystal bar 33 on the crystal holder 31. After the crystal bar 33 is cut, the holding mechanism 112 can control the crystal holder 31 to move away from the cutting shaft 111.

Both the first sidewall 141 and the second sidewall 151 are provided with axle holes 18 configured to mount ends of the cutting shaft 111. Both ends of the cutting shaft 111 can extend through an axle hole 18 on the first sidewall 141 and an axle hole 18 on the second sidewall 151, respectively. Thus, it could be understood that the axle holes 18 can be regarded as a marker to recognize the first sidewall 141 and the second sidewall 151. In the present embodiment, the cutting shaft 111 is in a horizontal state in the slicing chamber 11.

In some embodiments, the axle hole 18 on the first sidewall 141 and the axle hole 18 on the second sidewall 151 can be partly or completely replaced with a bearing, or other structures that can dispose the ends of the cutting shaft 111. For example, both the first sidewall 141 and the second sidewall 151 are provided with a bearing, respectively, to replace the two axle holes 18 in the present embodiment. That is, as long as the first sidewall 141 and the second sidewall 151 are provided with a mounting portion configured to dispose the cutting shaft 111, and both the axle hole 18 and the bearing are specific types of the mounting portion.

The number of the discharging port 10 is one, or multiple. All of the plurality of discharging ports 10 are in communication with the outside of the frame body 1, so that the crystal holder 31 can leave the slicing chamber from any one of the plurality of discharging ports 10. Since the unloading process can be completed manually and not relied on the mechanical hand 7 to unload, evenly when an unloading space overlaps with the human-operated region, the safety of the operator will not be influenced. Of course, in order let the mechanical hand 7 give way to the human-operated region in the process of unloading with the mechanical hand 7, in some embodiments, the feeding port 12 can be configured for unloading, and the feeding port 12 can play a role of the discharging port 10.

In the present embodiment, the loading process of the slicer is carried out at the rear end of the feeding channel 120, or at the feeding port 12. The unloading process of the slicer can be carried out at any one of the plurality of discharging ports 10. That is, the loading process and the unloading process of the slicer will not interfere with each other. In the process that the cut crystal bar 33 in the slicing chamber 11 gradually leaves the slicing chamber 11 from the discharging port 10, the uncut crystal bar 33 at the feeding port 12 can synchronously enter the slicing chamber 11. In the slicing chamber 11, the loading process and the unloading process can be carried out synchronously, so that time intervals between the loading process and the unloading process can be shortened. Therefore, the number of the crystal bars 33 entering the slicing chamber 11 in a permanent time can be improved, thereby improving a cutting efficiency of the crystal bar slicer.

The loading process of the crystal holder 31 at the rear end of the feeding channel 120 is completed by the mechanical hand 7. Thus, the rear end of the feeding channel 120 in the present embodiment is an opened structure, so as to provide a space configured for allowing the mechanical hand 7 to move. Similarly, all of the discharging port 10 can be an opened structure.

The crystal holder 31 is driven by the mechanical hand 7 to leave the slicing chamber 11 from the discharging port 10. Since the number of the discharging port 10 in the present embodiment is two, the mechanical hand 7 can pick up the crystal holder 31 at a suitable discharging port 10 according to actual technological process, and seldom limited by orientation of the frame body 1. Therefore, the process of picking up the material with the mechanical hand 7 is seldom limited, and the process of picking up the material is more smoothly. The process of the crystal holder 31 passing in and out the slicing chamber can be more smooth, so as to improve efficiency of cutting of the crystal bar 33.

The discharging port 10 can be disposed on the roof of the slicing chamber 11 and the bottom wall of the slicing chamber 11, or disposed on the roof of the slicing chamber 11 and the sidewalls of the slicing chamber 11, or disposed on the bottom wall of the slicing chamber 11 and the sidewalls of the slicing chamber 11, or all disposed on the sidewalls of the slicing chamber 11.

Furthermore, for example, the number of the discharging port 10 in the present embodiment is four. The four discharging port 10 are a first discharging port 14, a second discharging port 15, a fourth discharging port 13 and a fifth discharging port 16, respectively. The first discharging port 14 is located at the first sidewall 141. The second discharging port 15 is located at the second sidewall 151. The fourth discharging port 13 is located at the fourth sidewall 151. The fifth discharging port 16 is located at the roof of the slicing chamber 11. All of the first discharging port 15, the second discharging port 15 and the fifth discharging port 16 give way to the human-operated region. Therefore, if the material is unloaded at a plurality of discharging ports in the first discharging port 14, the second discharging port 15 and the fifth discharging port, the material can be unloaded by the mechanical hand 7 or manually unloaded. A space in front of the fourth discharging port 13 is the human-operated region. Thus, the loading process at the fourth discharging port 13 can only carried out manually.

For example, the mechanical hand 7 can unload material from the fifth discharging port 16 at the roof of the slicing chamber 11, and effectively give way to the operator. In addition, if the mechanical hand 7 configured to load the material and unload the material to the crystal bar slicer is a sky-rail robot 71, the higher the discharging port is, the more convenient it is to convey the crystal bar 33. Therefore, it is more convenient for the mechanical hand 7 to pick up the crystal holder 31 from the fifth discharging port 16.

Of course, a plurality of mechanical hands 7 can be used to pick up the crystal holder 31 from different discharging ports (except for the fourth discharging port 13), or, a corresponding mechanical hand 7 can be provided at each of the plurality of discharging ports (except for the fourth discharging port 13), and each of the plurality of mechanical hands 7 can pick up the crystal holder 31 from a certain discharging port.

In some embodiments, the crystal holder 31 can be driven by the holding mechanism 112 to move to the discharging port 10. In the present embodiment, the slicing chamber 11 is provided with a second pushing mechanism. The second pushing mechanism can be a protruding rod, a protrusion or other movable components. The second pushing mechanism can be configured to push the crystal holder 31 to outside of the slicing chamber 11. Specifically, a slicing station and a loading-unloading station are provided in the slicing chamber 11. The holding mechanism 11 can reciprocate between the slicing station and the loading-unloading state. When the holding mechanism 112 moves to the slicing station, the crystal bar contact the cutting line, and the corresponding crystal bar 33 can be cut. Then, the holding mechanism 112 can drive the crystal holder 31 and the cut crystal bar 33 to the loading-unloading station. At this time, the second pushing mechanism moves to push the crystal holder 31 and the crystal bar 33 to the outside of the slicing chamber 11 from the discharging port 10 and moved away by the mechanical hand 7. At the same time, the holding mechanism 112 can hold the crystal holder 31 and the uncut crystal bar 33 enter from the feeding port 12 at the loading-unloading station, thus when the holding mechanism 112 is at the loading-unloading station, the holding mechanism should be disposed opposite to the feeding port 12.

In some embodiments, the second pushing mechanism is disposed along a direction the first sidewall 141 opposite to the second sidewall 151. The first discharging port 14 is opposite to the second discharging port 15 along an axis of the second pushing mechanism. At this time, a moving direction of the second pushing mechanism is unitary, and is linear. Correspondingly, the structure of the second pushing mechanism is relative simple, but can push the crystal holder 31 from the first discharging port 14 or the second discharging port 15.

A height of the second pushing mechanism in the slicing chamber 11 is fixed. The height of the second pushing mechanism is approximately the same with a height of the first discharging port 14, a height of the second discharging port 15, a height of the feeding port 12 and a height of the fourth discharging port 13. Therefore, the holding mechanism 112 is movably disposed in the slicing chamber 11 along a height direction of the frame body 1, so that the holding mechanism 112 can reciprocate between the slicing station and the loading-unloading station. Correspondingly, the cutting shaft 111 is located below the first discharging port 14, the second discharging port 15, the feeding port 12 and the fourth discharging port 13, so as to avoid interference of the second pushing mechanism to the cutting shaft 111 when the second pushing mechanism acts.

The cutting shaft 111 is driven by an electric motor to rotate. Therefore, the crystal bar slicer in the present embodiment can further include a motor mounting base 2. The motor mounting base 2 is configured to dispose the electric motor. The motor mounting base 2 can be integrally formed on the frame body 1 to improve total rigidity of the frame body 1.

In an actual cutting process of the crystal bar 33, a distance between the electric motor and the cutting shaft 111 should be reduced as much as possible, so that the number of transmission structures and complexity of transmission structures between the electric motor and the cutting shaft 111 can be reduced. Therefore, the motor mounting base 2 can be located at the axle hole 18, and the motor mounting base 2 can be adjacent to an end of the cutting shaft 111. Correspondingly, a distance between the end of the cutting shaft 111 and the electric motor is relatively small.

Furthermore, since the fourth sidewall 131 and a top portion of the frame body 1 is not provided with a device such as the electric motor, a size of the fifth discharging port 16 and a size of the fourth discharging port 13 is relatively great, so that degree of freedom of picking up the material from the fifth discharging port 16 or the fourth discharging port 13 of the mechanical hand 7 or the operator can be improved.

In related art, the slicing chamber only includes a feeding port, and the human-operates space and the feeding port are disposed at both ends of the feeding channel. The slicing chamber in the related art does not include a first discharging port, a second discharging port, a fourth discharging port and a fifth discharging port. A loading process and an unloading process of the mechanical hand are carried out at the feeding port. The fourth sidewall of the frame body is provided with a line accommodating cavity, and a cutting line is provided in the line accommodating cavity. The cutting shaft rotates to drag the cutting line in the line accommodating cavity, so as to cut the crystal bar. Under the above conditions, if the fourth discharging port is provided at the fourth sidewall, the line accommodating cavity may shield the fourth discharging port and a size of the fourth discharging port is limited, thereby the unloading process at the fourth discharging port by the operator may be limited.

In view of above, the line accommodating cavity 17 is provided on a bottom of the frame body 1 in the present embodiment, so as to prevent line accommodating cavity 17 from shielding the fourth discharging port 13, thereby ensuring a size of the opening of the fourth discharging port 13.

Of course, in the related art, under conditions that the slicing chamber only includes a feeding port and the fourth sidewall is provided with the line accommodating cavity, influence of the line accommodating cavity can be avoided by providing a sixth discharging port on the bottom wall of the slicing chamber. That is, the sixth discharging port can replace the fourth discharging port. Of course, since space below the slicing chamber is limited and not convenient to convey the crystal bar 33, providing a sixth discharging port on the bottom wall of the slicing chamber is an alternative solution of the present embodiment.

It could be understood that in some embodiments, any one of the first discharging port 14, the second discharging port 15, the fourth discharging port 13 and the fifth discharging port 16 is reserved, or any two discharging ports 10 are reserved, or any three discharging ports 10 are reserved as an alternative solution of the present embodiment.

It could be understood that in some embodiments of the present disclosure, the position of the discharging port and the position of the feeding port can replace, as long as the loading process of the crystal bar slicer and the unloading process of the crystal bar slicer do not interfere with each other.

### Second Embodiment

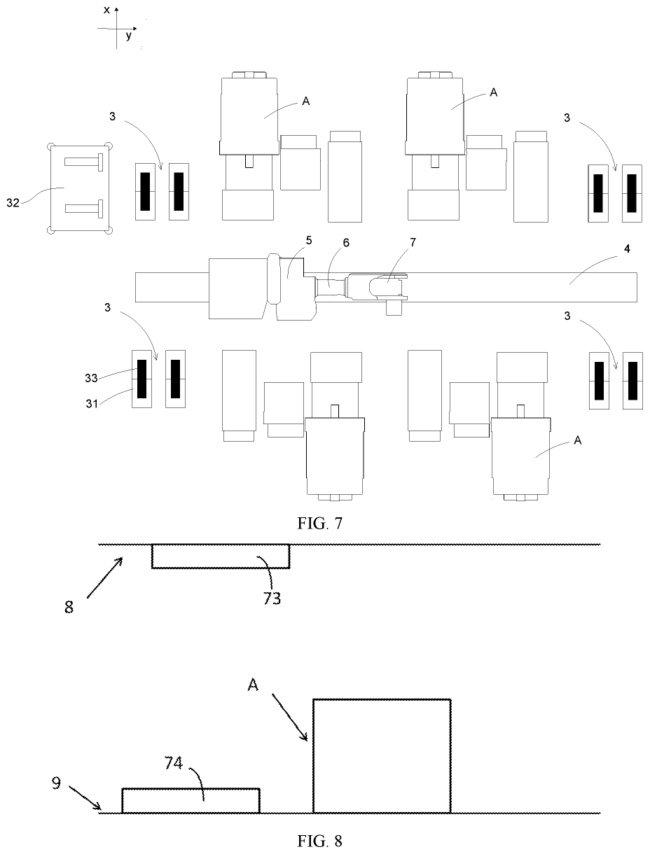

Referring to FIG. 7 and FIG. 8, the present embodiment provide a crystal bar slicing system, which includes a plurality of crystal bar slicers A in the first embodiment, a plurality of mechanical hand 7 and a plurality of stockpiling region 3. The number of the mechanical hand 7 and the number of the crystal bar slicer A is not determined. In some embodiments, the number of the mechanical hand 7 is only one, the mechanical hand 7 is configured to load the material or unload the material to the crystal bar slicer A. In some embodiments, the number of the mechanical hand 7 is multiple, a part of the plurality of mechanical hands 7 are loading mechanical hands, the other of the plurality of mechanical hands 7 are unloading mechanical hands. The loading mechanical hands are configured to load materials to the crystal bar slicer A, and the unloading mechanical hands are configured to unload materials to the crystal bar slicer. In some embodiments, each of the crystal bar slicer A is provided with a corresponding mechanical hand 7, and the mechanical hand 7 is responsible for the loading process and the unloading process of the corresponding crystal bar slicer A. For example, under conditions that each of the crystal bar slicer A is provided with one mechanical hand 7, the mechanical hand 7 is responsible for the loading process and the unloading process of the crystal bar slicer A. Under conditions that each of the crystal bar slicer A is provided with two mechanical hands 7, the two mechanical hands are responsible for the loading process of the crystal bar slicer A and the unloading process of the crystal bar slicer A.

In some embodiments, the loading mechanical hand is configured to pick up the crystal holder 31 and the uncut crystal bar 33 from the stockpiling region 3 and convey to the rear end of the feeding channel 120 or the feeding port. The unloading mechanical hand is configured to pick up the crystal holder 31 and the cut crystal bar 33 from the discharging port 10 and convey to the stockpiling region 3. Therefore, a large amount of crystal holders 31 are stored at the stockpiling region 3, and the uncut crystal bar 33 and the cut crystal bar 33 are pasted on the crystal holder 31. Ignoring the safety implications, the unloading mechanical hand in the present embodiment can unload the material at the fourth discharging port 13. In some embodiments, the unloading mechanical hand can pick up the crystal holder 31 and the cut crystal holder 33 from the rear end of the feeding channel 120 or the feeding port, so as to complete the unloading process.

The number of the stockpiling region 3 may be one or multiple. The loading mechanical hand and the unloading mechanical hand may pick up the material or release the material from the same stockpiling region 3 or different stockpiling regions 3. The stockpiling region 3 is movably disposed or fixedly disposed to the crystal bar slicer A. For example, when the stockpiling region 3 is a certain area on the ground, the stockpiling region 3 is fixed relative to the crystal slicer A. Alternatively, the stockpiling region 3 is an area for storing the crystal holder 31 on the material-conveying mechanism 32. At this time, the stockpiling region 3 can move along with the material-conveying mechanism 32, and the stockpiling region 3 can move relative to the crystal bar slicer A.

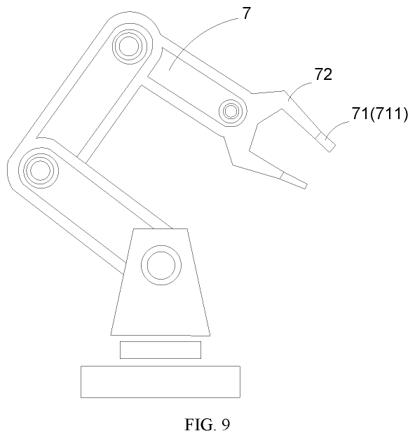

Referring to FIG. 9, in some embodiments, the mechanical hand 7 can rotate, lifting, stretching out or drawing back at a fixed position beside the crystal bar slicer A. Due to mechanical structure design of the mechanical hand 7 and/or programming of the mechanical hand 7, the mechanical hand 7 can have a preset moving region. The discharging port 10 of the crystal bar slicer A corresponding to the mechanical hand 7 can be located in the preset moving region of the mechanical hand 7, so as to meet space requirement of unloading the material from the discharging port 10 by the mechanical hand 7. In a similar way, the feeding port and/or the rear end of the feeding channel 120 of the crystal bar slicer A can be located in the preset moving region. Therefore, the mechanical hand 7 can load the material or unload the material from the feeding port and/or the feeding channel 120. Since the mechanical hand 7 cannot be moved, the stockpiling region can be disposed on the material-conveying mechanism. When the material-conveying mechanism moves to the preset moving region of the mechanical hand 7, the mechanical hand 7 can smoothly pick up or release the crystal holder 31 at the stockpiling region. Of course, requirement of picking up or releasing the crystal holder 31 of the mechanical hand 7 can be met by providing a plurality of stockpiling regions at permanent positions in the preset moving region of each of the plurality of mechanical hands 7. In some embodiments, the mechanical hand 7 can be provided with a first pushing mechanism 71. The first pushing mechanism 71 may be a protruding rod, a protrusion or other protruding structures. When the mechanical hand 7 is located at the rear end of the feeding channel 120, the mechanical hand 7 can stay still and push the crystal holder 31 into the slicing chamber by the first pushing mechanism 71, so as to avoid the mechanical hand 7 entering the feeding channel 120. Thus, limitation of the feeding channel 120 to the mechanical hand 7 is reduced.

In the present embodiment, the number of the crystal bar slicer A is multiple, in order to make the mechanical hand 7 reciprocate between the stockpiling region 3 and different crystal bar slicer A, the crystal bar slicing system can further include a sliding rail 4, and the mechanical hand 7 can be slidably disposed on the sliding rail 4. In some embodiments, the sliding rail 4 can be disposed on the ceiling, and the mechanical hand 7 can be a sky-rail robot 73. In some embodiments, the sliding rail 4 can be disposed on the ground, and the mechanical hand 7 can be a ground-rail robot 74.

All of the crystal bar slicers A can be disposed at one side or both sides of the sliding rail 4. In some embodiments, the crystal bar slicers A can be disposed at both sides of the sliding rail 4. The mechanical hands 7 can load the material or unload the material to the crystal bar slicers A at any position on the sliding rail 4. Under conditions that the number of the crystal bar slicers A is constant, a length of the sliding rail 4 can be shortened. The crystal bar slicers A at one side of the sliding rail 4 can be disposed side by side to reduce a distance between the crystal bar slicer A and the sliding rail 4, so as to reduce a moving distance of the mechanical hand 7 in the process of loading and unloading the material to the crystal bar slicer A.

Furthermore, an axis of the feeding channel 120 of each of the crystal bar slicers A and/or an axis of the discharging port 10 is perpendicular to the sliding rail 4, so that it is more convenient for the mechanical hand 7 to align with the discharging port 10 or the feeding channel 120 in the process that the mechanical hand 7 moves on the sliding rail 4, thereby facilitating the loading process and the unloading process of the mechanical hand 7. For example, in the present embodiment, an axis of the feeding port of each of the crystal bar slicers A and the fourth discharging port 13 of each of the crystal bar slicers A can be perpendicular to the sliding rail 4.

A height of the stockpiling region 3 is generally low, so that a total center of gravity of the crystal holder 31 in the stockpiling region 3 is lower. Thus, the crystal holder 31 can be disposed more stable. A height of the feeding port and a height of the discharging port 10 is generally relatively high. The corresponding mechanical hand 7 can be a sky-rail robot 73, so that it is more convenient for the mechanical hand 7 to give way to the operator in the loading process and the unloading process of the mechanical hand 7, thereby improving safety. Thus, there are height distances between the stockpiling region 3 and the feeding port or the discharging port 10. In order to allow the mechanical hand 7 to reciprocate between the stockpiling region 3 and the feeding port or between the stockpiling region 3 and the discharging port 10, a height of the mechanical hand 7 can be adjusted. Thus, a lifting mechanism 5 can be slidably disposed on the sliding rail 4. The mechanical hand 7 can be disposed on the lifting mechanism 5, so that the mechanical hand 7 can be slidably disposed on the sliding rail 4 via the lifting mechanism 5. The lifting mechanism 5 can drive the mechanism hand 7 to move along a height direction of the crystal bar slicer A. Of course, the mechanical hand 7 can have an extendable structure, so as to change the height of the mechanical hand 7.

Referring to FIG. 7, in the present embodiment, the sliding rail 4 can extend along a y axis (a horizontal axis). The lifting mechanism 5 can drive the mechanical hand 7 to move along a z axis (an axis perpendicular to a horizontal plane). When the mechanical hand 7 moves to one of the crystal bar slicers A, the mechanical hand 7 should be moved closer to or away from the feeding port or the discharging port 10 to facilitate the loading process and the unloading process. Thus, a moving mechanism 6 can be provided between the lifting mechanism 5 and the mechanical hand 7. The moving mechanism 6 can drive the mechanical hand 7 to move along the x axis. The x axis is parallel to the horizontal plane and perpendicular to the y axis and the z axis. After the mechanical hand 7 picks up the crystal holder 31, a length direction of the crystal holder 31 is parallel to the x axis, and perpendicular to the z axis. The lifting mechanism 5, the moving mechanism 6 and the sliding rail 4 can cooperate with each other, so that the mechanical hand 7 can move freely along three directions in which any two directions are perpendicular to each other. Thus, it is more convenient for the mechanical hand 7 to transfer the crystal holder 31 to the feeding channel 120 or away from the discharging port 10.

The lifting mechanism 5 can be an air cylinder or a linear actuator, or other normal devices or mechanism configured for lifting, and the skilled in the art can select the lifting mechanism 5 according to actual conditions. Similarly, the moving mechanism 6 can be an air cylinder or a linear actuator, so as to push or pull the mechanical hand 7.

In some embodiments, the mechanical hand 7 in the present embodiment is provided with a first pushing mechanism 71. The first pushing mechanism 71 can be a protruding rod, a protrusion or other protruding structures. The first pushing mechanism 71 also moves along a direction parallel to the x axis. Therefore, when the mechanical hand 7 is located at the rear end of the feeding channel 120, the mechanical hand 7 can stay still and push the crystal holder 31 into the slicing chamber by the first pushing mechanism 71, so as to avoid the mechanical hand 7 entering the feeding channel 120. Thus, limitation of the feeding channel 120 to the mechanical hand 7 is reduced.

As one of specific structures of the mechanical hand 7, the mechanical hand 7 includes two holding arms opposite to each other. The two holding arms can move close to or separate from each other, so as to cooperate with each other to hold the crystal holder 31 or release the crystal holder 31. The holding process does not require a very high degree of precision. Thus, the two holding arms can realize the holding process without precisely aligned with the crystal holder 31. When the holding arm is not precisely aligned with the crystal holder 31, the crystal holder 31 can naturally move close to the two holding arms along with the two holding arms moving close to each other, and finally the two holding arms stably hold the crystal holder 31. Corresponding, the mechanical hand 7 further includes an open-close mechanism. The open-close mechanism is disposed on the holding arm. The open-close mechanism is capable of controlling one of the holding arms to move, or simultaneously controlling the two holding arms to move. Thus, the two holding arms can move close to or separate from each other. When the two holding arms move close to each other, the tow holding arms can hold the crystal holder 31. When the two holding arms separate from each other, the two holding arms release the crystal holder 31.

In some embodiments, the holding arm is provided with a camera and a stress sensor. The camera is connected to a visual recognition module. The stress sensor is configured to test whether the holding arm holds the crystal holder 31. The holding arm can estimate whether the crystal holder 31 enters a holding space of the holding arm with the visual recognition module, so as to ensure that the holding arm aligns with the crystal holder 31. The stress sensor can ensure that the holding arm can carry the crystal holder only under conditions that the holding arm stably holds the crystal holder 31, thereby preventing the crystal holder 31 from falling and improving safety.

In some embodiments, as another kind of structure of the mechanical hand 7, the mechanical hand 7 in other embodiments can include a rod body and a clamping jaw, and the clamping jaw can hold or release the crystal holder 31 via the air cylinder.

### Third Embodiment

In the present disclosure, a loading method is provided on the basis of the crystal bar slicer in the first embodiment and the crystal bar slicing system in the second slicing system. The loading method includes the following steps.

Step 1: the mechanical hand 7 is driven by the lifting mechanism and the moving mechanism to move into the stockpiling region, so that the crystal holder 31 in the stockpiling region fall within the mechanical hand 7. The mechanical hand 7 picks up the crystal holder 31 and the uncut crystal bar 33 and moves to a rear end of the feeding channel 120, or directly moves to the feeding port.

Step S2: the mechanical hand 7 controls the center of gravity of the crystal holder 31 into the slicing chamber from the feeding channel 120, and then the holding mechanism 112 can support the crystal holder 31. At this time, the center of gravity of the crystal holder 31 falls on the holding mechanism 112, but the holding mechanism 112 is not locked by the crystal holder 31.

In some embodiments, the mechanical hand 7 includes two holding arms opposite to each other, the two holding arm cooperate to hold or release the crystal holder 31. Therefore, when the two holding arms hold the crystal holder 31, as long as a holding force of the two holding arms is equal to the gravity of the crystal holder 31, the two holding arms can stably hold the crystal holder 31. It is not necessary for the crystal holder 31 to fall on the holding arm. Therefore, when the crystal holder 31 is held by the holding arm, a large part of the crystal holder 31 locates outside of the holding arm, so that the crystal holder 31 can enter the feeding channel 120 and the slicing chamber under condition that the mechanical hand 7 does not enter the feeding channel 120, thereby avoiding obstruction of the mechanical hand 7 to the crystal holder 31 entering the feeding channel 120.

In the present step, the mechanical hand 7 can locate at the outside of the feeding channel 120, or partially enter the feeding channel 120, or partially enter the slicing chamber, which are not limited in the present embodiment.

Step S3: the center of gravity of the crystal holder 31 falls on the holding mechanism 112, so that the crystal holder 31 can be stably supported by the holding mechanism, even the holding arm no longer holds the crystal holder 31. Thus, the holding arm can release the crystal holder 31, and push the crystal holder 31 completely into the slicing chamber. Of course, after the holding arm crystal holder 31 release the crystal holder 31, the holding arm can continuously support the crystal holder 31, but the holding arm do not hold the crystal holder 31.

After the holding arm release the crystal holder 31, the crystal holder 31 can be pushed into the slicing chamber by three methods. First, the holding arm is provided with a first pushing mechanism, and the crystal holder 31 can be pushed into the slicing chamber with the first pushing mechanism. Since a volume of the holding arm is relatively great and a volume of the first pushing mechanism is relatively small, it is easier for the first pushing mechanism to push the crystal holder 31 into the slicing chamber. Second, the holding arm is provided with a protrusion. When the holding arm releases the crystal holder 31, the protrusion is corresponding to the crystal holder 31 along a length direction of the crystal holder 31, and the protrusion can mush the crystal holder 31 completely into the slicing chamber under the action of the moving mechanism. Third, when the holding arm releases the crystal holder 31, a part of the holding arm is corresponding to the crystal holder 31 along a length direction of the crystal holder 31. Under the action of the moving mechanism, the holding arm can push the crystal holder 31 completely into the slicing chamber. At this time, the part of the holding arm can enter the feeding channel 120.

Step 4: the mechanical hand 7 leaves the feeding port under the action of the moving mechanism and the lifting mechanism, and the crystal holder 31 separates from the mechanical hand 7 (if the mechanical hand 7 includes a first pushing mechanism, the first pushing mechanism restores at the same time).

### Fourth Embodiment

In the present disclosure, a loading method is provided on the basis of the crystal bar slicer in the first embodiment and the crystal bar slicing system in the second slicing system. The loading method includes the following steps.

Step S1″: the mechanical hand 7 picks up the crystal holder 31 and moves to the feeding channel 120 or the feeding port.

Step S2″: the slicing chamber is provided with a pulling mechanism, and the pulling mechanism pulls the crystal holder 31 into the slicing chamber.

In the process the pulling mechanism pulls the crystal holder 31, an end of the crystal holder 31 is at least supported by the pulling mechanism. In addition, the crystal holder 31 can be supported by at least one of the mechanical hand 7 and the holding mechanism 112, so that stability of the crystal holder 31 in the process entering the slicing chamber can be guaranteed.

### Fifth Embodiment

In the present disclosure, an unloading method is provided on the basis of the crystal bar slicer in the first embodiment and the crystal bar slicing system in the second slicing system. The unloading method includes the following steps.

Step S1′: the mechanical hand 7 is conveyed to the discharging port 10, and the mechanical hand 7 can partially enter the discharging port or not enter the discharging port 10. The skilled in the art can adjust the mechanism hand 7 according to specific technical parameters such as a size of the discharging port 10, which is not limited in the present step. At this time, the center of gravity of the crystal holder 31 is still on the holding mechanism 112 and supported by the holding mechanism 112.

Step S2′: a second pushing mechanism is disposed in the slicing chamber, the second pushing mechanism push the crystal holder 31 in the slicing chamber towards the mechanical hand 7, so that the center of gravity of the crystal holder 31 falls within the mechanical hand 7. In the process, the crystal holder 31 are stabilized and supported by the mechanical hand 7 and the holding mechanism 112 together.

In some embodiments, when the mechanical hand 7 is located at the discharging port 10, the mechanical hand 7 contacts an edge of the discharging port 10 or at least a part of the mechanical hand 7 locates in the slicing chamber, so that the center of gravity of the crystal holder 31 will not suspend in midair in the process the second pushing mechanism moves.

Step S3′: the mechanical hand 7 can lock the crystal holder 31.

In some embodiments, the mechanical hand 7 is disposed on the moving mechanism. If a part of the mechanical hand 7 locates in the slicing chamber, after the mechanical hand 7 locks the crystal holder 31, the moving mechanism controls the mechanical hand 7 to move away from the slicing chamber, so that the crystal holder 31 can be pulled out of the slicing chamber.

In the present embodiment, the mechanical hand 7 includes two holding arms opposite to each other, and the two holding arms cooperate with each other to hold or release the crystal holder 31. When the second pushing mechanism push the crystal holder 31 towards the holding arm. The holding arm can support a part of the crystal holder 31.

### Sixth Embodiment

In the present disclosure, an unloading method is provided on the basis of the crystal bar slicer in the first embodiment and the crystal bar slicing system in the second slicing system. The unloading method includes the following steps.

Step S1′″: the mechanical hand 7 is moved to the discharging port 10 or the feeding port or the feeding channel 120.

Step S2′″: the mechanical hand 7 pulled a part of the crystal holder 31 out of the slicing chamber, so that a center of gravity of the crystal holder 31 moves towards the discharging port 10 or the feeding port or the feeding channel 120. Of course, in the present step, the center of gravity of the crystal holder 31 is supported within the slicing chamber, for example, supported by the holding mechanism 112.

Step S3′″: the mechanical hand 7 enters the slicing chamber to support the center of gravity of the crystal holder 31.

At this time, since the center of gravity of the crystal holder 31 is closer to the discharging port 10 or the feeding port or the feeding channel 120 than the center of gravity of the crystal holder 31 in step S1′″, the mechanical hand 7 is easier to contact the center of gravity of the crystal holder 31 than in the step S1″″.

Step S4′″: the crystal holder 31 is conveyed out from the slicing chamber with the mechanical hand 7.

The present disclosure has the following benefits.

The feeding channel can provide a passage for the crystal holder and the crystal bar on the crystal holder to enter the slicing chamber, so that the crystal holder and the crystal bar can enter the slicing chamber through the feeding port. Then the holding mechanism can drive the crystal holder in the slicing chamber to move towards the cutting shaft, and cut the crystal bar with the cutting line on the cutting shaft. After the crystal bar is cut, the holding mechanism can drive the crystal holder out of the cutting shaft.

Since the feeding channel is located behind the slicing chamber, so that the mechanical hand can load the materials from the back side of the frame body, thereby giving way to the human-operated region in front of the frame body and effectively improving safety.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A crystal bar slicer, comprising a frame body, a cutting shaft and a holding mechanism, wherein the frame body is provided with a slicing chamber and a feeding channel, the slicing chamber is in front of the feeding channel, a rear sidewall of the slicing chamber is provided with a feeding port, a rear end of the feeding channel is in communication with outside of the frame body, a front end of the feeding channel is in communication with the slicing chamber via the feeding port, a crystal holder is capable of entering the slicing chamber through the feeding channel, the cutting shaft is disposed in the slicing chamber, the holding mechanism is configured to drive the crystal holder to move towards or away from the cutting shaft.

2. The crystal bar slicer of claim 1, wherein the rear end of the feeding channel is open, and configured to provide a space for allowing a mechanical hand to move.

3. The crystal bar slicer of claim 1, wherein a sidewall of the slicing chamber is further provided with at least one discharging port, the at least one discharging port is in communication with the outside of the frame body, and the crystal holder is capable of leaving the slicing chamber through the at least one discharging port.

4. The crystal bar slicer of claim 1, wherein the feeding port is configured to allow the crystal holder and a cut crystal bar to leave the slicing chamber.

5. A crystal bar slicing system, comprising a crystal bar slicer of claim 1, a mechanical hand and a stockpiling region, and
the mechanical hand is configured to pick up a crystal holder and a crystal bar to be cut from the stockpiling region and convey the crystal holder and the crystal bar to be cut to a slicing chamber.

6. The crystal bar slicing system of claim 5, wherein the mechanical hand is further configured to pick up the crystal holder and a cut crystal bar from the discharging port and/or the feeding port, and convey the crystal holder and the cut crystal bar to the stockpiling region.

7. The crystal bar slicing system of claim 6, wherein the mechanical hand is capable of moving in a preset moving region, the discharging port is located in the preset moving region, and the feeding port and/or a rear end of the feeding channel are located in the preset moving region.

8. The crystal bar slicing system of claim 7, wherein the stockpiling region is located on a material-conveying mechanism,
when the material-conveying mechanism moves to the preset moving region, the mechanical hand is capable of picking up the crystal holder from the stockpiling region or placing the crystal holder on the stockpiling region.

9. The crystal bar slicing system of claim 6, wherein the crystal bar slicing system further includes a sliding rail, the sliding rail is disposed on a ceiling or a floor, and the mechanical hand is slidably disposed on the sliding rail, so that the mechanical hand is capable of moving between the stockpiling region and the crystal bar slicer.

10. The crystal bar slicing system of claim 9, comprising a plurality of the crystal bar slicers, all of the plurality of crystal bar slicers are disposed at one side of the sliding rail or beside both sides of the sliding rail, the plurality of crystal bar slicers disposed at the same side of the sliding rail are disposed side-by-side, and a feeding channel of each of the plurality of crystal bar slicers is perpendicular to the siding rail.

11. The crystal bar slicing system of claim 5, wherein the mechanical hand is provided with a first pushing mechanism, when the mechanical hand is carrying the crystal holder, the first pushing mechanism is configured to push the crystal holder to the slicing chamber.

12. The crystal bar slicing system of claim 5, wherein the mechanical hand comprises two holding arms opposite to each other, the two holding arms cooperate with each other to clip or release the crystal holder.

13. The crystal bar slicing system of claim 5, wherein the stockpiling region is movable or fixed relative to the crystal bar slicer.

14. A method of loading material of a crystal bar slicer, comprising,
picking up a crystal holder with a mechanical hand, and conveying the crystal holder to a feeding channel or a feeding port;
controlling the crystal holder and placing the crystal holder in a slicing chamber;
completely pushing the crystal holder into the slicing chamber; and
controlling the mechanical hand to separate the mechanical hand from the crystal holder, or,
picking up a crystal holder with a mechanical hand and conveying the crystal holder to a feeding channel or a feeding port; and
conveying the crystal holder into a slicing chamber with a pulling mechanism disposing in the slicing chamber.

15. The method of loading material of the crystal bar slicer of claim 14, wherein the mechanical hand is provided with a first pushing mechanism, and the first pushing mechanism is configured to completely push the crystal holder into the slicing chamber.

16. The method of loading the material of the crystal bar slicer of claim 14, wherein a process of completely pushing the crystal holder into the slicing chamber comprises following steps:
the mechanical hand is provided with a protrusion, after the crystal holder is separated from the mechanical hand, the protrusion is opposite to the crystal holder, so that the protrusion is capable of pushing the crystal holder completely into the slicing chamber, or,
after the crystal holder is separate from the mechanical hand, a part of the mechanical hand is opposite to the crystal holder, so that the mechanical hand is capable of pushing the crystal holder completely into the slicing chamber.

17. The method of loading the material of the crystal bar slicer of claim 16, wherein the mechanical hand is disposed on a moving mechanism, and the moving mechanism is configured to control the mechanical hand to push the crystal holder to the slicing chamber.

18. The method of loading the material of the crystal bar slicer of claim 14, wherein the mechanical hand comprises two holding arms disposed opposite to each other, the two holding arms cooperate with each other to clip or release the crystal holder,
the two holding arms is capable of clipping the crystal holder and transferring the crystal holder to the slicing chamber, so that a center of gravity of the crystal holder transfers to the slicing chamber, and then releasing the crystal holder.
